(19) United States
(12) Patent Application Publication
(10) Pub. No.: US 2015/0132585 A1
(43) Pub. Date: May 14, 2015

(54) Phosphor Ceramics and Methods of Making the Same

(71) Applicant: Nitto Denko Corporation, Osaka (JP)

(72) Inventors: Guang Pan, Carlsbad, CA (US); Jiadong Zhou, San Diego, CA (US); Hironaka Fujii, Carlsbad, CA (US); Bin Zhang, San Diego, CA (US); Amane Mochizuki, Carlsbad, CA (US)

(21) Appl. No.: 14/394,188

(22) PCT Filed: Apr. 18, 2013
(86) PCT No.: PCT/US13/37247

§ 371 Date: Oct. 13, 2014

Related U.S. Application Data
(60) Provisional application No. 61/635,131, filed on Apr. 18, 2012.

(51) Int. Cl. C09K 11/77; C09K 11/61; C04B 35/645

(52) U.S. Cl. CPC C09K 11/7774; C04B 35/645; C09K 11/617; C04B 2235/9646; C04B 2235/666
USPC 428/446; 264/21; 252/301.4 F

(57) ABSTRACT

Electric sintering of precursor materials to prepare phosphor ceramics is described herein. The phosphor ceramics prepared by electric sintering may be incorporated into devices such as light-emitting devices, lasers, or for other purposes.

### CROSS REFERENCE

This application claims the benefit of U.S. Provisional Patent Application No. 61/635,131 filed on Apr. 18, 2012, the content of which is hereby incorporated by reference in its entirety.

### FIELD

Disclosed herein are methods of preparing ceramic materials such as phosphor ceramics by Spark Plasma Sintering (SPS). Also disclosed herein are ceramic materials made according to such methods, and devices comprising these ceramic materials.

### BACKGROUND

Use of light-emitting diodes (LED) for lighting has attracted more attention in recent years as an energy saving light source. White light can be generated by a combination of an LED with a blue emission line and phosphors with a yellow or yellow green emission line. For example, the cerium-doped yttrium aluminum garnet (YAG), Y₃Al₅O₁₂:Ce³⁺, may be used in such applications.

Compared with phosphor particles in a polymer matrix, ceramic inorganic materials have a higher thermal conductivity and a polycrystalline microstructure. Inorganic ceramic materials appear to be more stable in high temperature and moisture environments. Phosphor materials in a dense ceramic form can be an alternative to conventional particulate matrix applications. Such a ceramic made of consolidated phosphor powders can be prepared by conventional sintering processes.

In general, ceramics can be manufactured by various processes such as vacuum sintering, controlled atmosphere sintering, uniaxial hot pressing, hot isostatic pressing (HIP), and so on. In order to get densified ceramics, the application of relatively high temperatures and/or pressures may be necessary. Useful phosphors include oxides, fluorides, oxyfluoride sulfide, oxisulfides, nitrides, oxynitrides, etc. Among them, some systems are vulnerable to high temperature due to the decomposition of the phosphor, and are thus difficult to sinter.

Some drawbacks of conventional sintering processes include long cycle times and slow heating and cooling rates. In addition, for some thermally unstable phosphor powders, prolonged exposure to high temperature can cause the decomposition or degradation of the powder, leading to completely or partial loss of luminescence. It may also be difficult to consolidate samples with large area and small thickness because the sintered pieces may become warped.

### SUMMARY

Precursor compositions for inorganic ceramics may be sintered by applying an electric current, such as a pulse electric current, to the precursor compositions. This sintering method may be used to produce a dense phosphor ceramic. The sintering may be carried out under pressure, such as a pressure of about 1 MPa to about 300 MPa. Sintering temperatures may also be lower than those used for conventional sintering processes.

Some methods of preparing dense phosphor ceramics comprise: heating a multi-elemental composition to sinter the composition by applying a pulse electric current to the composition at a pressure between about 1 MPa to about 300 MPa; wherein the method produces a dense phosphor ceramic.

Some embodiments include methods of preparing a dense phosphor ceramic, comprising: heating a multi-elemental composition to sinter the composition by applying a pulse electric potential to the composition at a pressure of about 1 MPa to about 300 MPa; wherein the method produces a dense phosphor ceramic.

Some embodiments include methods comprising providing multi-elemental composition; applying a pulse electric current effective to cause heating of the multi-elemental composition to a hold temperature; and applying to the multi-elemental composition a pressure of about 1 MPa to about 300 MPa and a temperature below conventional sintering process temperatures.

Some embodiments include an emissive layer comprising a ceramic made as described herein. An embodiment provides a lighting device comprising the emissive layer described herein.

Some embodiments include a method of preparing a dense phosphor ceramic, comprising: heating a multi-elemental composition to sinter the composition by applying a pulse electric current to the composition at a pressure of about 1 MPa to about 300 MPa, wherein the multi-elemental composition comprises a fluoride or fluoride precursor; wherein the method produces a dense phosphor ceramic. In some embodiments the multi-elemental composition further comprises a dopant material.

These and other embodiments are described in greater detail below.

### BRIEF DESCRIPTION OF THE DRAWINGS

FIG. 1 is a diagram of an example of a press for an electric sintering process.

FIG. 2 is a processing flowchart for preparing some embodiments of phosphor ceramics from powder precursors using electric sintering.

FIG. 3 is a processing flowchart for preparing some embodiments of phosphor ceramics from green sheet laminates using electric sintering.

FIG. 4 depicts a configuration used an example of multi-piece sintering of phosphor ceramics by an electric sintering process.

FIG. 5 depicts a configuration for co-sintering two different phosphor powders or pre-sintered ceramics plates.

FIG. 6 shows an example of one way that a phosphor ceramic may be integrated into a light-emitting device (LED).

FIG. 7 is a photoluminescent spectrum of the YAG:Ce³⁺/K₂SiF₆:Mn⁴⁺ (i.e., [potassium hexafluorosilicate, or PHFS]:Mn⁴⁺) layered phosphor ceramic of Example 2.

FIG. 8 is a plot comparing the Color Rendering Index (CRI) of integration of the YAG:Ce³⁺/PHFS:Mn⁴⁺ ceramic plate of Example 2 with a YAG:Ce³⁺ ceramic plate.

FIG. 9 is a photoluminescent spectrum of the co-sintered YAG:Ce³⁺/PHFS:Mn⁴⁺ phosphor ceramic of Example 3.

### DETAILED DESCRIPTION

Generally, in the embodiments of the present methods a multi-elemental composition is heated to sinter the mixture by applying a pulse electric potential or pulse electric current (referred to collectively herein as “electric sintering”) to the composition to provide a dense phosphor ceramic. This may allow fast heating or cooling rates, shorter sintering times, and/or shorter sintering temperatures. Since electric sintering may occur at a lower temperature than conventional sintering, it may be used to sinter materials that are unstable at conventional sintering temperatures. Electric sintering may also provide a homogeneous and stable emissive phosphor in comparison with conventional phosphor powders suspended polymer matrices. Electric sintering can also allow the integration of more than one kind of phosphor, e.g. nitrides, fluorides, silicates, aluminates, oxynitrides, etc. into ceramic phosphor compacts having improved Color Rendering Index at adjusted color temperatures. Furthermore, electric sintering may provide a way to consolidate phosphors which are thermally instable. Electric sintering may be carried out while the composition is under pressure. In some embodiments, phosphor powders can be consolidated to fully dense or close to fully dense ceramics by electric sintering at lower temperatures for a very short duration, and in a vacuum or an adjusted atmosphere.

In some embodiments, a multi-elemental composition may be sintered by Spark Plasma Sintering (SPS). Unlike a conventional hot press sintering process, SPS does not employ a heating element or conventional thermal insulation of the vessel. Instead, a special power supply system feeds high current into water-cooled machine rams, which act as electrodes, simultaneously feeding the high current directly through the pressing tool and the material the pressing tool contains. This construction leads to a homogeneous volume heating of the pressing tool as well as the powder it contains by means of Joule heat. This results in a favorable sintering behavior with less grain growth and suppressed powder decomposition. SPS techniques can lead to smaller generated grain size in the resultant products, generally on the order of nanometers. By using SPS techniques, phosphor powders may be consolidated in a short time, on the order of minutes instead of hours, as in conventional sintering procedures. In some embodiments, the sintering may be accomplished by heating the material for about 1 minute to about 60 minutes, about 10 minutes to about 40 minutes, about 20 minutes to about 30 minutes, about 25 minutes, about 10 minutes, or about 5 minutes.

Any suitable pressure may be applied during the sintering process. In some embodiments, sintering may be carried out at a pressure of about 1 MPa to about 300 MPa, about 1 MPa to about 200 MPa, about 1 MPa to about 100 MPa, about 5 MPa to about 200 MPa, about 15 MPa to about 150 MPa, about 35 MPa to about 120 MPa, about 0.01 MPa to about 300 MPa, about 25 MPa to 200 MPa, about 30 MPa to about 100 MPa, about 30 MPa to about 50 MPa, about 40 MPa, about 100 MPa or any pressure in a range bounded by, or between, any of these values. Pressure may be applied by a graphite press. For graphite presses it may be desirable to apply pressures that are about 40 MPa or less. For some presses employing alternative materials such as steel die and punches, higher pressures than 40 MPa may be used.

An electric potential, such as a pulse electric potential, may be applied to a multi-element composition in order to sinter the material. The electric potential applied to a multi-element composition causes a current, such as a pulse electric current, to flow through the multi-element composition and/or through material of a press or other sintering device containing the multi-element composition. The current may heat the multi-element composition to sinter the composition. The time and nature of the electric current may vary. In some embodiments, a pulse electric current may be applied. The time of a pulse current may vary. For example, a pulse may be about 0.5 milliseconds (ms) to about 10 ms, about 1 ms to about 5 ms, about 3 ms, or about 3.3 ms in length, or may be any length of time in a range bounded by, or between, any of these values. A rise time, or period of time in which current increases, for an electric pulse may vary. In some embodiments, an electric pulse may have a rise time of about half, or slightly less than half, that of the pulse time, such as about 30% to about 50%, about 40% to about 49%, or about 45%, of the length of the pulse. For example, a 3.3 ms pulse may have a rise time of about 1.5 ms. In some embodiments, a pulse electric current may have a pattern. For example, 12 pulses of 3.3 ms duration with a rise time of about 1.5 ms may be followed by 2 pulses of 3.3 ms non-electrified pulses.

Any suitable level of electric current may be applied. In some embodiments, an electric current may be between about 20 A to about 2,000 A, about 50 A to about 200 A, about 100 A, or about 500 A.

Initially, if a multi-element composition is a powder with many voids, or if the powder is an insulator, the electric current may run through the sintering press material (or the material of any sintering device containing the material) and thus externally heat the multi-element composition by heat transfer from the sintering device to the composition. A multi-element composition having fewer and/or smaller voids (either because a more compact composition is initially used, or because pressure applied to a multi-element composition has reduced the number and/or size of the voids), or an electrically conductive multi-element composition, may have the electric current run through the composition. Thus, a multi-element composition may be heated by electric current flowing through the composition itself. As a result, a multi-element composition may be internally heated by the current through the composition in addition to any external heating of the composition that may occur, either by current flow through the press, or other sources of external heat. In some embodiments, internal and/or external heating that results from applying an electric potential to the multi-element composition that results in an electric current can cause a temperature rise rate of about 10° C./min to about 300° C./min, about 10° C./min to about 200° C./min, about 50° C./min to about 200° C./min, or about 100° C./min. In some embodiments, the temperature may be increased for about one minute to about 60 min, about 5 min to about 30 min, about 10 min to about 20 min, or about 5 min before holding the multi-element composition at a relatively constant temperature.

A multi-element composition may be heated by electric current to a holding temperature (or temperature range), and then held at the holding temperature to continue the sintering process. In some embodiments, the holding temperature (or temperature range) may be below conventional sintering process temperatures, and can be such as about 100° C. to about 800° C., about 100° C. to about 600° C., about 200° C. to about 500° C., about 400° C. to about 500° C., about 450° C., about 500° C., or any temperature in a range bounded by, or between, any of these values. A multi-element composition may be held at the holding temperature for any suitable holding time. In some embodiments, the holding time may be about 1 min to about 10 hr, about 1 min to about 2 hr, about 1 min to about 1 hr, about 1 min to about 30 min, about 5 min to about 30 min, about 10 min, about 20 min, or any amount of time in a range bounded by, or between, any of these values.

Pressure can be applied at a variable rate, which is consistent with a heating ramp, or faster or slower than a heating ramp. In some embodiments, the maximum pressure can be applied at the beginning of heating and held at that pressure until the desired temperature has been applied for the requisite time or until the target temperature has been achieved.

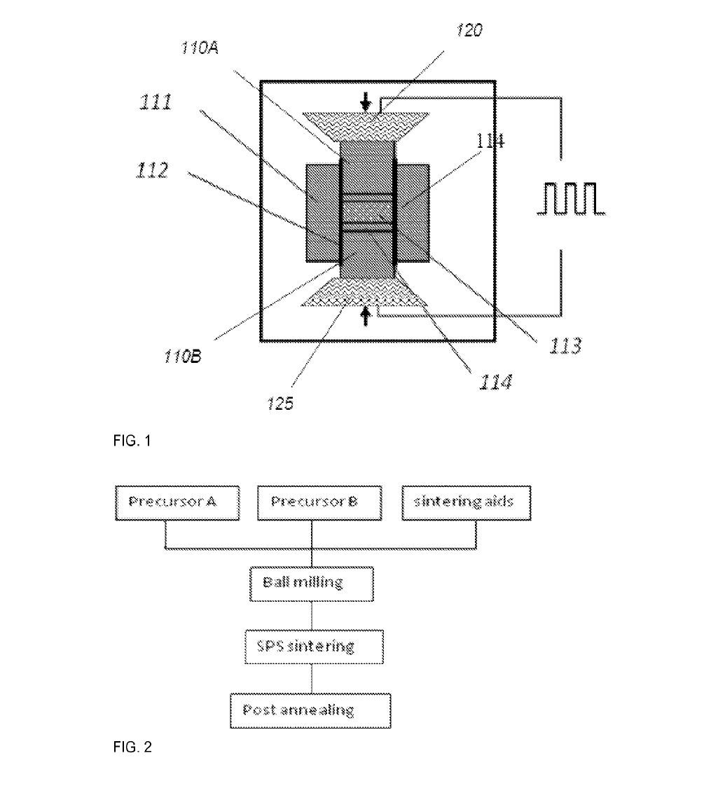

FIG. 1 depicts an assembly that may be used for a pulsed electric current sintering. A multi-elemental composition 113, such as fluoride powder (e.g., complete doped powders, such as K₂SiF₆:Mn⁴⁺ and K₂TiF₆:Mn⁴⁺ (in this example, Mn⁴⁺ activated) and/or precursor host materials and intermediates such as K₂SiF₆ and K₂MnF₆) can be loaded into a die 111, such as a steel die, and sandwiched with two punches 110A and 110B, such as for example steel punches, separated from the fluoride phosphor powder 113 by spacers 112 and 114, such as for example molybdenum or graphite spacers. The assembly of phosphor powders can be set in between two rams 120 and 125, such as for example graphite rams, which also act as electrodes for pulse electric current flowing through the multi-elemental composition. The setup can be enclosed in a chamber which can be operating in vacuum or other desired atmospheric conditions or environments. DC pulse electric voltage is applied to the electrodes/rams at adjustable on-off time, preferably 12 pulses on-2 pulses off. For example, a series of twelve pulses of 100 A, 3.3 ms in duration with a rise of 1.5 ms can be applied, followed by two non-electrified pulses. Uniaxial pressure can be applied to the powders though the rams and punches during heating.

After sintering, a phosphor ceramic may be annealed by heating the phosphor and holding for a period of time. For example, a ceramic phosphor may be annealed by holding the ceramic phosphor at about 1,000° C. to about 2,000° C., about 1,200° C. to about 1,600° C., about 1,200° C., or about 1,400° C. The ceramic phosphor may be held for as long as desired to obtain the desired annealing effect, such as about 10 min to about 10 hr, about 30 min to about 4 hr, or about 2 hr.

For some phosphor ceramics, a second annealing may be done under reduced or vacuum pressure. For example, a phosphor ceramic may be annealed at a pressure of about 0.001 Torr to about 50 Torr, about 0.01 Torr, or about 20 Torr. Temperatures for a reduced pressure annealing may depend upon the desired effect. In some embodiments, a second annealing may be at a temperature of about 1,000° C. to about 2,000° C., about 1,200° C. to about 1,800° C., or about 1,800° C., at the reduced pressure. A second annealing may be carried out for as long as desired to obtain the effect sought, such as about 10 min to about 10 hr, about 30 min to about 4 hr, or about 5 hr.

A multi-elemental composition may include any composition comprising at least two different atomic elements.

A multi-elemental composition may comprise a bi-elemental fluoride, including a compound containing at least two different atomic elements, wherein at least one of the two different elements includes fluorine.

A multi-elemental composition may comprise a bi-elemental non-fluoride, including a compound containing at least two different atomic elements, wherein the two different elements do not include fluorine.

A multi-elemental composition may comprise a bi-elemental oxide, including a compound containing at least two different atomic elements, wherein at least one of the two different elements includes oxygen.

A multi-elemental composition may comprise a bi-elemental non-oxide, including a compound containing at least two different atomic elements, wherein the two different elements do not include oxygen.

In some embodiments, a multi-elemental composition can be a precursor host material. A precursor host material refers to any material that can be “activated” by having one or more atoms in a solid structure replaced by a relatively small amount of a dopant, which takes a position in the solid host structure that was occupied by the atoms it replaces. In some embodiments, the multi-elemental composition can be a precursor host material comprising a single inorganic chemical compound; e.g., PHFS powder or YAG powder. In other embodiments, a multi-elemental composition can comprise multiple precursor materials, such as K₂MnF₆ and K₂SiF₆.

In some embodiments, a multi-elemental composition may include a host-dopant material, such as a material that is primarily a single solid state compound in which a small amount of one or more atoms in the host structure are substituted by one or more non-host (dopant) atoms.

In some embodiments the multi-elemental composition can further comprise a dopant or dopant precursor. A dopant precursor is a component that contains one or more atoms that can substitute one or more atoms in a host material to form a host-dopant material. In some embodiments, the dopant can comprise a complete phosphor powder/dopant; e.g., K₂SiF₆:Mn⁴⁺. In some embodiments, the dopant can comprise a dopant precursor. Suitable dopant precursors include compounds or materials that include atoms or ions such as, e.g., Ce, Eu, Tm, Pr, Cr, or Mn. Other suitable dopant precursors include the respective metal oxide of the desired dopant atom or ion; e.g., oxides of Tm, Pr, Cr, etc. Examples of dopant precursors include, but are not limited to, CeO₂, Ce(NO₃)₃.6H₂O, Ce₂(O₃)₃, EuN, and K₂MnF₆. In some embodiments, the dopant can comprise a rare earth compound or a transition metal. In some embodiments, the dopant can comprise Mn⁴⁺, Ce³⁺, and/or Eu²⁺.

Examples of multi-elemental compositions comprising activated host-dopant fluoride materials (with examples of precursor materials) can include, but are not limited to: K₂[SiF₆]:Mn⁴⁺ (K₂[SiF₆] and K₂[MnF₆]); K₂[TiF₆]:Mn⁴⁺ (K₂[TiF₆] and K₂[MnF₆]); K₃[ZrF₇]:Mn⁴⁺ (K₃[ZrF₇] and K₂[MnF₆]); Ba_{0.65}Zr_{0.36}F_{2.70}:Mn⁴⁺ (Zr[OH]₄, BaCO₃ and K₂[MnF₆]); Ba[TiF₆]:Mn⁴⁺ (TiO₂, BaCO₃ and K₂[MnF₆]); K₂[SnF₆]:Mn⁴⁺ (K₂SnO₃.3H₂O and K₂[MnF₆]); Na₂[TiF₆]:Mn⁴⁺ (Na₂[TiF₆] and K₂[MnF₆]); and, Na₂[ZrF₆]:Mn⁴⁺ (Na₂[ZrF₆] and K₂[MnF₆]).

A multi-elemental composition can have an average grain size diameter of about 0.1 μm to about 20 μm, about 1 μm to about 150 μm, or about 0.1 μm to about 20 μm.

In some embodiments, the multi-elemental composition can comprise a garnet, a garnet precursor, a fluoride, or a fluoride precursor. As used herein, a “garnet” includes any material that would be identified as a garnet by a person of ordinary skill in the art, and any material identified as a garnet herein. In some embodiments, the term “garnet” refers to the tertiary structure of an inorganic compound, such as a mixed metal oxide.

In some embodiments, the garnet may be composed of oxygen and at least two different elements independently selected from the groups II, III, IV, V, VI, VII, VIII or Lanthanide metals. For example, the garnet may be composed of oxygen and a combination of two or more of the following elements: Ca, Si, Fe, Eu, Ce, Gd, Tb, Lu, Nd, Y, La, In, Al, and Ga.

In some embodiments, a synthetic garnet may be described as A₃D₂(EO₄)₃, wherein A, D, and E are elements selected from group II, III, IV, V, VI, VII, VIII elements, and Lanthanide metals. A, D, and E may either represent a single element, or they may represent a primary element that represents the majority of A, D, or E, and a small amount of one or more dopant elements also selected from group II, III, IV, V, VI, VII, VIII elements, and Lanthanide metals. Thus, the above formula may be expanded to:

(primary A+dopants)₃(primary D+dopants)₂([primary E+dopants]O₄)₃.

In a garnet particle, the primary element or dopant element atom of A (e.g., Y³⁺) may be in a dodecahedral coordination site or may be coordinated by eight oxygen atoms in an irregular cube. Additionally, the primary element or dopant element atom of D (e.g., Al³⁺, Fe³⁺, etc.) may be in an octahedral site. Finally, the primary element or dopant element atom of E (e.g., Al³⁺, Fe³⁺, etc.) may be in a tetrahedral site.

In some embodiments, a garnet can crystallize in a cubic system, wherein the three axes are of substantially equal lengths and perpendicular to each other. In these embodiments, this physical characteristic may contribute to the transparency or other chemical or physical characteristics of the resulting material. In some embodiments, the garnet may be yttrium iron garnet (YIG), which may be represented by the formula Y₃Fe₂(FeO₄)₃ or (Y₃Fe₅O₁₂). In YIG, the five iron(III) ions may occupy two octahedral and three tetrahedral sites, with the yttrium(III) ions coordinated by eight oxygen ions in an irregular cube. In YIG, the iron ions in the two coordination sites may exhibit different spins, which may result in magnetic behavior. By substituting specific sites with rare earth elements, for example, interesting magnetic properties may be obtained.

Some embodiments comprise metal oxide garnets, such as Y₃Al₅O₁₂ (YAG) or Gd₃Ga₅O₁₂ (GGG), which may have desired optical characteristics such as transparency or translucency. In these embodiments, the dodecahedral site can be partially doped or completely substituted with other rare-earth cations for applications such as phosphor powders for electroluminescent devices. In some embodiments, specific sites are substituted with rare earth elements, such as cerium. In some embodiments, doping with rare earth elements or other dopants may be useful to fine tune properties such as optical properties. For example, some doped compounds can luminesce upon the application of electromagnetic energy. In phosphor applications, some embodiments are represented by the formula (A₁₋ₓREₓ)₃D₅O₁₂, wherein A and D are divalent, trivalent, quadrivalent or pentavalent elements; A may be selected from, for example, Y, Gd, La, Lu, Yb, Tb, Sc, Ca, Mg, Sr, Ba, Mn and combinations thereof; D may be selected from, for example, Al, Ga, In, Mo, Fe, Si, P, V and combinations thereof; and, RE may be a rare earth metal or a transition element selected from, for example, Ce, Eu, Tb, Nd, Pr, Dy, Ho, Sm, Er, Cr, Ni, and combinations thereof. This compound may be a cubic material having useful optical characteristics such as transparency, translucency, or emission of a desired color.

In some embodiments, a garnet may comprise yttrium aluminum garnet, Y₃Al₅O₁₂ (YAG). In some embodiments, YAG may be doped with neodymium (Nd³⁺). YAG prepared as disclosed herein may be useful as the lasing medium in lasers. Embodiments for laser uses may include YAG doped with neodymium and chromium (Nd:Cr:YAG or Nd/Cr:YAG); erbium-doped YAG (Er:YAG), ytterbium-doped YAG (Yb:YAG); neodymium-cerium double-doped YAG (Nd:Ce:YAG, or Nd,Ce:YAG); holmium-chromium-thulium triple-doped YAG (Ho:Cr:Tm:YAG, or Ho,Cr,Tm:YAG); thulium-doped YAG (Tm:YAG); and chromium (IV)-doped YAG (Cr:YAG). In some embodiments, YAG may be doped with cerium (Ce³⁺). Cerium doped YAGs may be useful as a phosphors in light emitting devices such as light emitting diodes and cathode ray tubes. Other embodiments include dysprosium-doped YAG (Dy:YAG); and, terbium-doped YAG (Tb:YAG), which are also useful as phosphors in light emitting devices.

A garnet precursor can include any composition that can be heated to obtain a garnet. In some embodiments, a garnet precursor comprises an oxide of yttrium, an oxide of aluminum, an oxide of gadolinium, an oxide of lutetium, an oxide of gallium, an oxide of terbium, or a combination thereof. Some examples of garnet precursors include Y₂O₃, Al2O₃, and CeO₂.

In some embodiments, the dense phosphor ceramic comprises a garnet having a formula (Y₁₋ₓCeₓ)₃Al₅O₁₂, wherein x is about 0 to about 0.05, about 0.001 to about 0.01, about 0.005 to about 0.02, about 0.008 to about 0.012, about 0.009 to about 0.011, about 0.003 to about 0.007, about 0.004 to about 0.006, or about 0.005.

In some embodiments, the dense phosphor ceramic comprises CaAlSiN₃:Eu²⁺, wherein the Eu²⁺ is about 0.001 atom % to about 5 atom %, about 0.001 atom % to about 0.5 atom %, about 0.5 atom % to about 1 atom %, about 1 atom % to about 2 atom %, about 2 atom % to about 3 atom %, about 3 atom % to about 4 atom %, or about 4 atom % to about 5 atom %, based upon the number of Ca atoms.

In some embodiments, the dense polymer ceramic can include a nitride host material having a quaternary host material structure represented by a general formula M-A-B—F:Z. Such a structure may increase the emission efficiency of a phosphor. In some embodiments, M is a divalent element, A is a trivalent element, B is a tetravalent element, N is nitrogen, and Z is a dopant/activator in the host material.

M may be Mg, Be, Ca, Sr, Ba, Zn, Cd, Hg, or a combination thereof. A may be B (boron), Al, Ga, In, Ti, Y, Sc, P, As, Sb, Bi, or a combination thereof. B may be C, Si, Ge, Sn, Ni, Hf, Mo, W, Cr, Pb, Zr, or a combination thereof. Z may be one or more rare-earth elements, one or more transition metal elements, or a combination thereof.

In the nitride material, a mole (or mol) ratio Z/(M+Z) of the element M and the dopant element Z may be about 0.0001 to about 0.5. When the mol ratio Z/(M+Z) of the element M and the activator element Z is in that range, it may be possible to avoid decrease of emission efficiency due to concentration quenching caused by an excessive content of the activator. A mol ratio in that range may also help to avoid a decrease of emission efficiency due to an excessively small amount of light emission contributing atoms caused by an excessively small content of the activator. Depending on the type of the activating element Z to be added, the effect of the percentage of Z/(M+Z) on emission efficiency may vary. In some embodiments, a Z/(M+Z) mol ratio in a range from 0.0005 to 0.1 may provide improved emission.

For a composition wherein M is Mg, Ca, Sr, Ba, Zn, or a combination thereof, raw materials can be easily obtained and the environmental load is low. Thus, such a composition may be preferred.

For a composition wherein M is Ca, A is Al, B is Si, and Z is Eu in a material, raw materials can be easily obtained and the environmental load is low. Additionally, the emission wavelength of a phosphor having such a composition is in the red range. A red based phosphor may be capable of producing warm white light with a high Color Rendering Index (CRI) at adjusted color temperature when combined with blue LED and yellow phosphors. Thus, such a composition may be preferred.

A nitride precursor includes any composition that can be heated to obtain a nitride. Some useful nitride precursors can include Ca₃N₂ (such as Ca₃N₂ that is at least 2N), AlN (such AlN as that is at least 3N), and/or Si₃N₄ (such as Si₃N₄ that is at least 3N). The term 2N refers to a purity of at least 99% pure. The term 3N refers to a purity of at least 99.9% pure.]

In some embodiments, a multi-elemental composition can comprise phosphor powders. Phosphor powders can include, but are not limited to, fluorides of silicon, titanium, potassium, sodium, phosphorus, aluminum, boron, tungsten, vanadium, molybdenum, or combinations thereof. Phosphor powders can also include sulfides, oxides, oxysulfides, oxyfluorides, nitrides, carbides, nitridobarates, chlorides, phosphor glass or combinations thereof.

In some embodiments a multi-element composition comprises at least one of: (a) A₂[MF₆]:Mn⁴⁺, where A is Li, Na, K, Rb, Cs, NH₄, or a combination thereof, and where M is Ge, Si, Sn, Ti, Zr, or a combination thereof; (b) E[MF₆]:Mn⁴⁺, where E is Mg, Ca, Sr, Ba, Zn, or a combination thereof, and where M is Ge, Si, Sn, Ti, Zr, or a combination thereof; (c) A₂[MF₅]:Mn⁴⁺, where A is Li, Na, K, Rb, Cs, NH₄, or a combination thereof, and where M is Al, Ga, In, or combination thereof; (d) Ba_{0.65}Zr_{0.35}F_{2.70}:Mn⁴⁺; (e) (E) A₃[MF₆]:Mn⁴⁺, where A is Li, Na, K, Rb, Cs, NH₄, or a combination thereof, and where M is Al, Ga, In, or combination thereof; (f) Zn₂[MF₇]:Mn⁴⁺, where M is Al, Ga, In, or a combination thereof; (g) A[In₂F₇]:Mn⁴⁺, where A is Li, Na, K, Rb, Cs, NH₄, or a combination thereof; and, (h) A₃[ZrF₇]:Mn⁴⁺, where A is Li, Na, K, Rb, Cs, NH₄, or a combination thereof.

Examples of Mn⁴⁺ activated multi-element compositions of this embodiment can be K₂[SiF₆]:Mn⁴⁺; K₂[TiF₆]:Mn⁴⁺; K₃[ZrF₇]:Mn⁴⁺; Ba_{0.65}Zr_{0.35}F_{2.70}:Me; Ba[TiF₆]:Mn⁴⁺; K₂[SnF₆]:Mn⁴⁺; Na₂[Ti F₆]:Mn⁴⁺; and, Na₂[Zr F₆]:Mn⁴⁺. Complex fluoride phosphors doped with Mn⁴⁺ with a coordination number of 6 for the coordination center (i.e., in a generally octahedral environment, as in K₂[TiF₆]:Mn⁴⁺ and K₂[SiF₆]:Mn⁴⁺) are particularly preferred. Other complex fluorides with higher coordination numbers for the central ion (e.g., K₃[ZrF₇], with a coordination number of 7) are also applicable as host lattices for activation with Me. In some embodiments, the phosphor composition is selected from K₂TiF₆ and K₂SiF₆.

In some embodiments, a multi-elemental composition may be a pre-form of a phosphor powder. A pre-form may be made by compacting a phosphor powder at uniaxial or isotropic pressure.

Sintering a multi-elemental composition using an electric current can produce a ceramic material as a product. In some embodiments, such a ceramic material can have a theoretic density (meaning the percent density of the material when compared to a solid material with no voids) of at least 70%, at least 75%, at least 80%, at least 85%, at least 90%, at least 95%, at least 97%, or at least 99%, and may approach 100%. Some YAG ceramic products may have a density of about 4.3 g/mL to about 4.6 g/mL, about 4.4 g/mL to about 4.55 g/mL, or about 4.51 g/mL.

In some embodiments, the electrically sintered ceramic material has a resultant grain size of about 0.1 μm to about 50 μm; 0.1 μm to about 20 μm; about 20 μm to about 40 μm, about 0.5 μm to about 15 μm; about 1 μm to about 10 μm; about 1 μm to about 5 μm; or about 30 μm.

In some embodiments, electric sintering a complete host or precursor material may be done while the material is on a sintered ceramic plate. A ceramic plate can be synthesized, for example, by methods described in U.S. Patent Publication No. US2009-0212697, Ser. No. 12/389,207, filed Feb. 19, 2009; U.S. Patent Publication No. US2011-0210658, Ser. No. 13/016,665, filed Jan. 28, 2011, and Provisional Application Ser. No. 61/625,796, filed Apr. 18, 2012. The term “complete host material” refers to a host material with a complete stoichiometric formula; e.g., a complete YAG powder could be Y₃Al₅O₁₂ powder, and a complete fluoride powder could be K₂SiF₆. Precursor materials for YAG could include Al₂O₃, Y₂O₃, etc.

Some embodiments include a ceramic plate prepared by electric sintering. In some embodiments, a sintered ceramic plate can comprise a plurality of sintered plates laminated to one another.

In some embodiments, a ceramic compact is provided comprising a first layer comprising garnet material and a second layer comprising a fluoride material. In some embodiments, a ceramic compact comprises a garnet material and a fluoride material in a single layer. In other embodiments, the ceramic compact comprises a garnet material in a first layer and a fluoride material in a second layer. In some embodiments, the garnet material can be an yttrium garnet such as Y₂Al₅O₁₂. In other embodiments, the garnet material can be a Ce³⁺ doped yttrium garnet such as Y₂Al₅O₁₂:Ce³⁺. In some embodiments, the fluoride material can be K₂SiF₆ or K₂TiF₆, which may be Mn⁴⁺ doped; e.g., to provide K₂SiF₆:Mn⁴⁺ or K₂TiF₆:Mn⁴⁺, respectively.

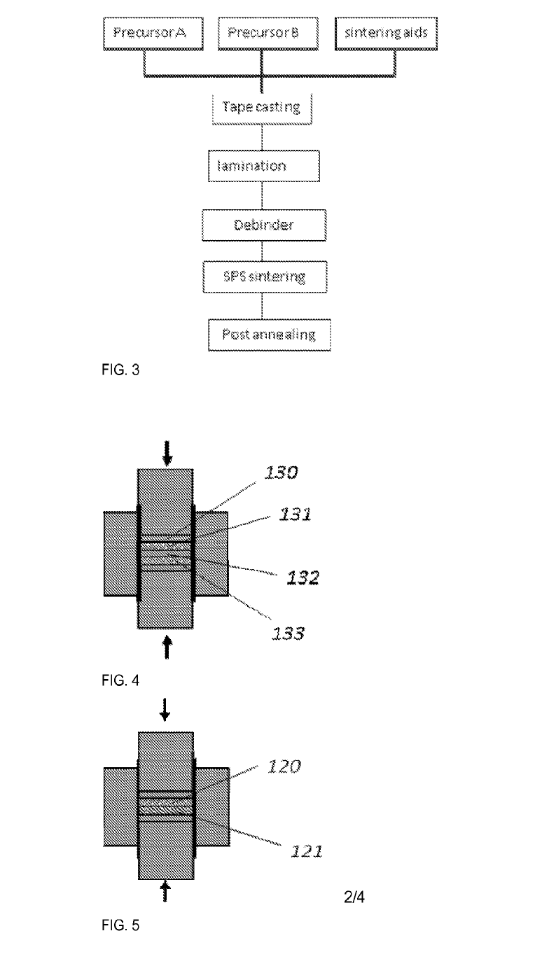

FIGS. 2 and 3 show examples of processes for sintering phosphor ceramics (e.g., garnet and/or fluoride host materials) by electric sintering.

In some embodiments, phosphor ceramics can be formed by reaction of precursors and consolidation of reaction product by treating the precursors with electric sintering conditions. FIG. 2 shows an example of such a process. Precursor powders, e.g. Precursor A and Precursor B, optionally mixed with any sintering aid(s), may be mixed by ball milling. The milled precursor powder may then be treated by electric sintering conditions (SPS sintering) followed by annealing.

Ball milling may be carried out in a planetary ball milling machine for reducing precursor size, achieving homogeneous mixing of precursors and increasing reactivity by the defects formed on precursor powders. Useful ball milling rates may be in a range of about 500 rpm to about 4,000 rpm, about 1,000 rpm to about 2,000 rpm, or about 1,500 rpm. Ball milling may be carried out for a period of time that is adequate to provide the desired effect. For example, ball milling may be carried out for about 150 min, about 0.5 hr to about 100 hr, about 2 hr to about 50 hr, or about 24 hr.

In processes as depicted in FIG. 3, precursor materials, such as Precursor A and Precursor B, are mixed, optionally with sintering aids. The mixture may then be tape-cast to form pre-forms of plates. The pre-formed plates are then stacked as laminates (lamination). The laminates may comprise green sheets containing one kind of phosphor powder or more than one kind of phosphor powder. The laminates can also comprise more than one kind of green sheet containing phosphor. The resultant laminate can then be heated and held at a temperature above 400° C. to burn out the organic components before electric sintering (the debinder process). The laminate is then treated by electric (SPS) sintering and annealed.

In some embodiments, a dense phosphor ceramic may have an internal quantum efficiency (IQE) of at least 70%, at least 75%, at least 80%, at least 85%, at least 90%, at least 95%, at least 97%, or at least 99%.

As shown in FIG. 4, in some embodiments, two or more multi-element compositions 131 and 133, such as phosphor green sheet laminates or phosphor powders, may be separated by a spacer 132, such as a graphite or molybdenum spacer, during electric sintering. After sintering, plural phosphor ceramics pieces are obtained.

In some embodiments, a combination of two or more phosphor powders or pre-sintered ceramic plates are co-sintered by electric sintering to obtain a phosphor ceramic with a different emission spectrum than either individual phosphor powder. FIG. 5 shows the configuration for an embodiment of such a process. Phosphor A 120, comprising a first phosphor powder or a first pre-sintered ceramic plate, and phosphor B 121, comprising a second phosphor powder or a second pre-sintered ceramic plate, are sintered together in an electric sintering device.

In some embodiments, pre-sintered phosphor ceramic plates and phosphor powders are co-sintered by electric sintering, wherein the phosphor powder has a different emission spectrum than the ceramic plate. This may form a consolidated phosphor ceramic that integrates more than one kind of phosphor with different emission peak wavelengths, thus adjusting the color rendering index.

In some embodiments, fluoride phosphor materials, e.g., fluoride phosphors such as K₂SiF₆:Mn⁴⁺ and/or fluoride precursor powders such as K₂MnF₆, K₂SiF₆, etc., are disposed upon a sintered phosphor ceramic, such as YAG:Ce³⁺, and sintered by electric sintering. After electric sintering, stacking of plural phosphor ceramics pieces may be obtained.

In some embodiments, phosphor ceramics having a dopant concentration gradient may be formed by sintering laminates of plural green sheets by electric current. In these embodiments, each green sheet may contain phosphor powder with a different dopant concentration. Thus, when sintering is complete, a single ceramic having a dopant concentration gradient may be formed from the fusion of the green sheets.

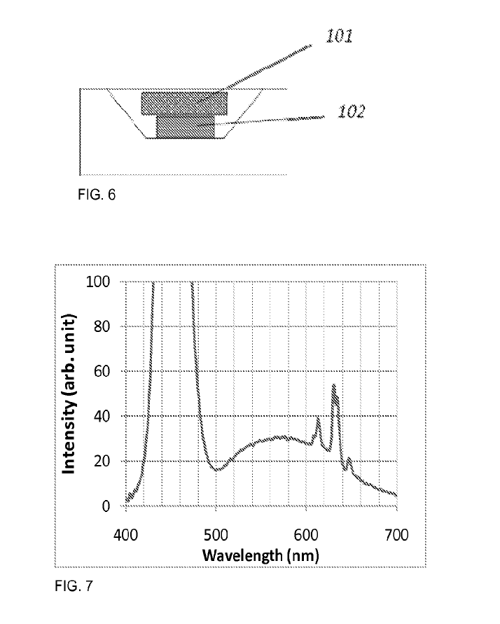

FIG. 6 shows an example of one way that a phosphor ceramic may be integrated into an LED. A phosphor ceramic 101 may be disposed above a light-emitting diode 102 so that light from the LED passes through the phosphor ceramic before leaving the system. Part of the light emitted from the LED may be absorbed by the phosphor ceramic and subsequently converted to light of a lower wavelength by luminescent emission. Thus, the color of light-emitted by the LED may be modified by a phosphor ceramic such as phosphor ceramic 101.

### EXAMPLES

Embodiments of phosphor ceramics as described herein can be prepared by Spark Plasma Sintering. The ceramics obtained by these methods can be used in light sources of warm white with high CRI. These benefits of the present methods and ceramics are further shown by the following examples, which are intended to be illustrative of various embodiments of the disclosure, but are not intended to limit the scope or underlying principles of the disclosure in any way.

### Example 1

### Process for Synthesizing Fluoride Red Phosphor by Reactive Spark Plasma Sintering

Intermediate K₂MnF₆ was synthesized according to Bode's method. See H. Bodes et al. Angew. Chem. N11 (1953), page 304. Briefly, KHF₂ (30 g, Sigma-Aldrich), KMnO₂ (1.5 g, Sigma-Aldrich, 99%), and HF (100 ml, 50 wt %) were mixed until the solids were completely dissolved. Hydrogen peroxide (1.5 ml) was then added dropwise. When hydrogen peroxide addition was complete, the mixture was filtered, rinsed with acetone then water, and dried at ambient atmosphere and room temperature to yield K₂MnF₆.

A precursor powder was prepared by ball milling (at about 1500 rpm, for about 150 min.) a combination of K₂MnF₆ (1.40 g, prepared as described above), K₂SiF₆ (5.00 g), and ethanol (20 mL) using a 3 mm ZrO₂ ball in a 250 mL Al₂O₃ jar. The resulting slurry was dried at 80° C. for 1 hr. to yield the precursor powder.

SPS sintering was performed under a vacuum of about 7.5×10⁻² Torr in a Dr. Sinter SPS-515S apparatus (Sumitomo Coal Mining Co. Ltd.). Precursor powder (1.56 g), made as described above, was compacted in a steel die with an inner diameter of 13 mm and a wall thickness of 50 mm. The powder was separated from the steel punches by spacers made of molybdenum foil of about 0.5 mm in thickness. Two steel cylinder punches with the same diameter as the dies were pushed into the steel die onto the spacer. This assembly was set in a vacuum chamber between two high-strength graphite plungers, which were kept in contact with the steel punches at both sides at an initial uniaxial pressure of 2.8 kNf. The graphite plungers also worked as the electrodes during sintering. DC on-off pulse voltage was applied to the electrodes simultaneously. The duration of the pulse was 3.3 ms with a rise time of about 1.5 ms, with a current of about 100 A at 500° C. A thermocouple mounted on the wall of the steel die was used for monitoring and controlling the temperature during sintering. The precursor powder was heated up to about 500° C. at rate of 100° C./min, and kept at 500° C. for about 20 min with an applied pressure of about 13.9 kNf corresponding to about 100 MPa at the beginning of heating. The applied pressure was then released to the initial uniaxial pressure (2.8 kNf) at the end of the temperature holding duration (e.g., about 20 min) to yield the bulk red phosphor K₂(Si₁₋ₓMnₓ)F₆.

### Example 2

### Co-Firing of YAG:Ce³⁺ and PHFS Red Phosphor

Integration of YAG:Ce phosphor ceramics with fluoride red phosphor was carried out by using SPS sintering. A YAG:Ce³⁺ ceramic was prepared by laminating green sheets as follows: a mixture of Al₂O₃ and Y₂O₃ precursors were tape-casted at a stoichiometric ratio of YAG (Y₃Al₅O₁₂), along with an organic polymer binder, a plasticizer, tetraethyl orthosilicate (TEOS) corresponding to 0.5 wt % of SiO₂ as a sintering aid, and 0.4 atom % of Ce with respect to yttrium content as an activator for photoluminescence. The laminates with a thickness of 540 μm were cut into a circular shape with a diameter of 16 mm, heated to 1,200° C. at a heating rate of 2° C./min, and held for 2 hr at 1,200° C. to burn out the organic constituent and partially consolidate the precursors.

A second sintering was carried out in a vacuum furnace (Centorr Vacuum Industries) under a vacuum of about 10⁻³ Torr. The material was heated at a rate of 5° C./min to 1,800° C., and held for 5 hr. The sintered YAG:Ce³⁺ ceramic plates with a diameter of 12.9 mm were annealed in a tube furnace at low pressure of 20 Torr to cure the oxygen vacancy formed during vacuum sintering.

Co-firing of the sintered YAG:Ce³⁺ ceramic plate prepared above and PHFS (K₂SiF₆:Mn⁴⁺) red phosphor powder was carried out under a vacuum of about 7.5×10⁻² Torr in a Dr. Sinter SPS-515S apparatus (Sumitomo Coal Mining Co. Ltd.). PHFS red phosphor (0.11 g) with a nominal Mn content of 10 atom % and average particle size of 30 μm was added and compacted into a steel die with an inner diameter of 13 mm and wall thickness of 5 mm, and then the sintered YAG:Ce³⁺ ceramic plate was loaded onto the compact PHFS powder. The assembly of YAG:Ce³⁺ ceramic plate and PHFS red phosphor powder was separated by carbon fiber felt spacers of 2 mm in thickness and pressed by steel punches on both sides of the assembly. The assembly was set in an SPS chamber between two graphite electrodes. Firing was performed at a minimum uniaxial pressure of 2.7 kNf corresponding to 25 MPa on the 13 mm die. DC pulse voltage with an on-off pattern of 1 on pulse followed by 9 off pulses was applied to the electrodes simultaneously. The duration of the pulse was 3.3 ms with a rise time of the order of 1.5 ms, with a current of about 100 A.

The sample assembly was heated in vacuum of 10 Pa from room temperature to 400° C. in 20 min, then to 450° C. in 3 min, and kept at 450° C. for 10 min. Cooling of the sample assembly was finished in 25 min from 450° C. to room temperature. A type K thermal couple was used to monitor and control the heating and cooling temperatures. A YAG:Ce³⁺ ceramic plate integrated with PHFS red phosphor having a thickness of about 300 μm was obtained.

The color rendering index of the sample above was measured with a Multi-channel Photo Detector system (Otsuka Electronics MCPD 7000, Japan) together with required optical components such as integrating spheres, light sources, monochromator, optical fibers and so on. The obtained sample showed a general Color Rendering Index of 90.

The photoluminescence spectrum of the layered plate obtained in this Example is shown in FIG. 7.

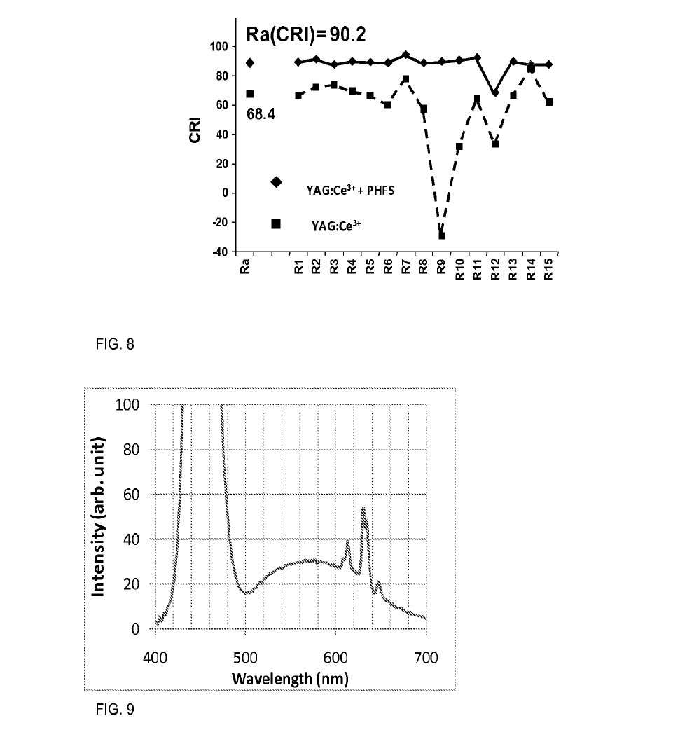

A plotted comparison of the Color Rendering Index (CRI) of the integrated YAG:Ce³⁺/PHFS (K₂SiF₆:Mn⁴⁺) fluoride red phosphor ceramic plate with a YAG:Ce³⁺ ceramic plate is depicted in FIG. 8.

### Example 3

### Co-Firing of YAG:Ce³⁺ Phosphor Powder with PHFS Red Phosphors

YAG:Ce³⁺ powder with Ce content of x=1.5 atom % with respect to Y as described by the formula as (Y₁₋ₓCeₓ)₃Al₅O₁₂ was co-fired with PHFS red phosphor by SPS. A powder mixture of YAG:Ce³⁺ and PHFS red phosphor was prepared for SPS sintering by mixing plasma-synthesized YAG:Ce³⁺ powder (0.1270 g, (Y₁₋ₓCeₓ)₃Al₅O_{12;} x=0.015) with PHFS [0.512 g, (K₂(Si₁₋ₓMnₓ)F₆; x=0.01)] in an agate mortar. The powder mixture (0.184 g) was loaded into a steel die with a diameter of 13 mm. The powder mixture and steel punches were separated by spacers of Mo foil. The assembly was sintered under a vacuum of about 10 Pa at about 450° C. for about 5 min with applied uniaxial pressure of 100 MPa by following the procedure as that in EXAMPLE (1) with an on-off pattern of 12-2. The photoluminescence spectrum of the sample is shown in FIG. 9.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A method of preparing a dense phosphor ceramic, comprising:
sintering a multi-elemental composition by applying heat and a pulse electric current to the composition at a pressure of about 1 MPa to about 300 MPa, wherein the multi-elemental composition comprises a fluoride material;
wherein the method produces a dense phosphor ceramic.

2. The method of claim 1, wherein the electric current is about 20 A to about 2,000 A.

3. The method of claim 1, wherein the electric current is about 100 A.

4. The method claim 1, wherein the multi-elemental composition is heated to a temperature of about 100° C. to about 800° C.

5. The method of claim 1, wherein the multi-elemental composition is heated to a temperature of about 400° C. to about 500° C.

6. The method of claim 1, wherein applying the pulse electric current causes a temperature rise of the material at a rate of about 10° C./min to about 600° C./min.

7. The method of claim 1, wherein applying the pulse electric current causes a temperature rise of the material at a rate of about 100° C./min.

8. The method of claim 1, wherein the fluoride material comprises K₂SiF₆ and/or K₂TiF₆.

9. The method of claim 1, wherein the fluoride material is a powder.

10. The method of claim 1, wherein the multi-elemental composition further comprises a dopant material.

11. The method of claim 10, wherein the dopant comprises Mn or K₂MnF₆.

12. The method of claim 1, wherein the fluoride material comprises (a) K₂SiF₆:Mn⁴⁺ or (b) K₂MnF₆ and K₂SiF₆.

13. The method of claim 1, further comprising adding the multi-elemental composition upon a sintered ceramic plate.

14. The method of claim 1, wherein the multi-elemental composition comprises at least two precursor materials.

15. The method of claim 1, wherein the multi-elemental composition comprises at least one multi-elemental host powder.

16. The method of claim 13, wherein the sintered ceramic plate comprises yttrium aluminum garnet or Ce³⁺ doped yttrium aluminum garnet.

17. A sintered ceramic plate prepared according to the method of claim 1.

18. A sintered ceramic plate of claim 17, comprising a plurality of sintered plates that are laminated to each other.

19. A ceramic compact comprising a first layer comprising garnet material and a second layer comprising a fluoride material.

20. The compact of claim 19, wherein the garnet material is an yttrium garnet.

21. The compact of claim 19, wherein the fluoride material is K₂SiF₆ or K₂TiF₆.

22. A method of preparing a dense phosphor ceramic, comprising:
sintering a multi-elemental composition by applying heat and applying a pulse electric potential to the composition at a pressure between about 1 MPa to about 300 MPa, wherein the multi-elemental composition comprises a fluoride material;
wherein the method produces a dense phosphor ceramic.
